(19) United States
(12) Patent Application Publication
(10) Pub. No.: US 2026/0268942 A1
(43) Pub. Date: Sep. 10, 2026

(54) DISK DEVICE

(71) Applicants: KABUSHIKI KAISHA TOSHIBA, Kawasaki-shi (JP); Toshiba Electronic Devices & Storage Corporation, Kawasaki-shi (JP)

(72) Inventors: Masaki MORITA, Yokohama (JP); Yasuhiko KATO, Tokyo (JP); Hirofumi SUZUKI, Kawasaki (JP)

(73) Assignees: KABUSHIKI KAISHA TOSHIBA, Kawasaki-shi (JP); Toshiba Electronic Devices & Storage Corporation, Kawasaki-shi (JP)

(21) Appl. No.: 19/365,317

(22) Filed: Oct. 22, 2025

(30) Foreign Application Priority Data
Mar. 5, 2025 (JP) 2025-034825

(51) Int. Cl. G11B 33/14; G11B 25/04

(52) U.S. Cl. CPC G11B 33/146; G11B 25/043

(57) ABSTRACT

A disk device includes a base, a cover, a magnetic disk, and a filter. The base with an internal space includes a support surface, an inner peripheral surface, an outer surface, and a gate located on the outer surface. The internal space is recessed from the support surface in a first direction along an axis. The internal space includes a disk chamber inside the inner peripheral surface, a filter chamber opening on the inner peripheral surface to communicate with the disk chamber, and a flow path opening on the inner peripheral surface, allowing the disk chamber and the filter chamber to communicate with each other, and being located between the gate and the disk chamber. In the first direction, a distance between the support surface and an end of the flow path is shorter than a distance between the support surface and an end of the filter chamber.

### CROSS-REFERENCE TO RELATED APPLICATIONS

This application is based upon and claims the benefit of priority from Japanese Patent Application No. 2025-034825, filed on March 5, 2025; the entire contents of which are incorporated herein by reference.

### FIELD

Embodiments described herein relate generally to a disk device.

### BACKGROUND

A disk device such as a hard disk drive (HDD) typically includes various kinds of components such as magnetic disks, magnetic heads, and a filter, and a housing that houses the components. The filter collects predetermined substances from inside the housing to allow each magnetic head to stably float above the corresponding magnetic disk.

For example, the housing includes a base that houses the magnetic disks and the magnetic heads. The base is provided with a flow path in the vicinity of the magnetic disks. The filter is disposed in the flow path. Airflow, when caused by rotation of the magnetic disk, is guided into the filter through the flow path.

The bases are manufactured using, for example, a mold. The material of the base is filled into the mold through the gate. In the mold, the material flows around a part for forming recesses such as the flow path in the base. That is, the shape of the flow path may affect the fluidity or flow of the base material.

### BRIEF DESCRIPTION OF THE DRAWINGS

FIG. 1 is an exemplary perspective view illustrating an HDD according to a first embodiment in an exploded manner;

FIG. 2 is an exemplary plan view illustrating a base of the first embodiment;

FIG. 3 is an exemplary cross-sectional view illustrating a portion of the housing of the first embodiment taken along line F3-F3 of FIG. 2;

FIG. 4 is an exemplary perspective view illustrating a part of the base and a filter of the first embodiment;

FIG. 5 is an exemplary perspective view illustrating a part of the base of the first embodiment;

FIG. 6 is an exemplary cross-sectional view schematically illustrating the base and a mold of the first embodiment;

FIG. 7 is an exemplary perspective view illustrating a part of the base according to a second embodiment.

### DETAILED DESCRIPTION

In general, according to one embodiment, a disk device includes a base, a cover, a magnetic disk, and a filter. The base is provided with an internal space. The base includes a support surface, an inner peripheral surface extending around an axis, an outer surface opposite the inner peripheral surface, and a gate located on the outer surface. The internal space is recessed from the support surface in a first direction along the axis, and is filled with a gas. The cover is supported by the support surface to seal the internal space. The magnetic disk is disposed in the internal space to be rotatable around the axis with respect to the base. The filter is disposed in the internal space and configured to collect a substance different from the gas. The internal space includes a disk chamber located inside the inner peripheral surface to house the magnetic disk, a filter chamber opening on the inner peripheral surface to communicate with the disk chamber and house the filter, and a flow path opening on the inner peripheral surface away from the filter chamber around the axis, allowing the disk chamber and the filter chamber to communicate with each other, and being located between the gate and the disk chamber. In the first direction, a distance between the support surface and an end of the flow path is shorter than a distance between the support surface and an end of the filter chamber.

### First Embodiment

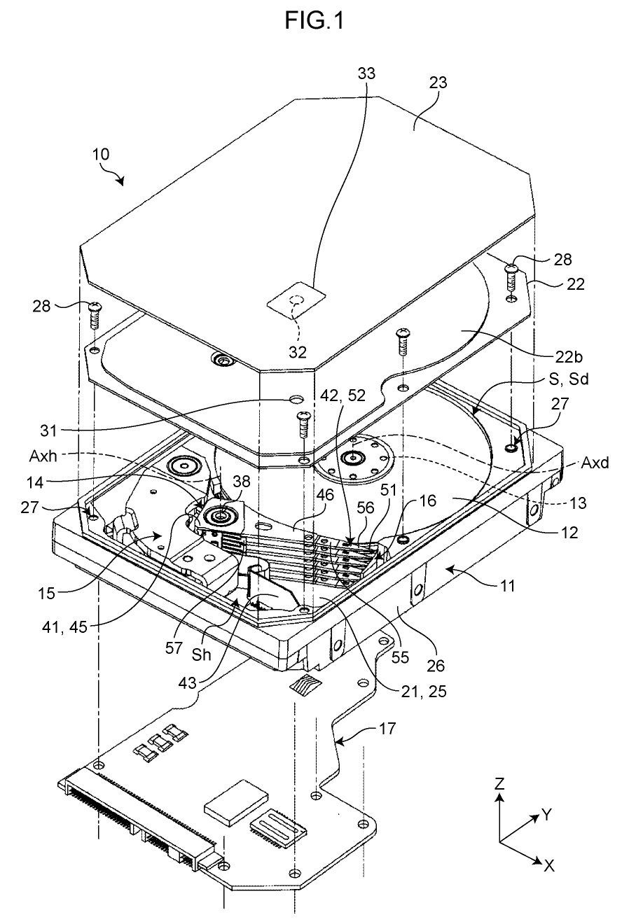

Hereinafter, a first embodiment will be described with reference to FIGS. 1 to 6. Note that, in the present specification, component elements according to embodiments and descriptions of the elements may be described in a plurality of expressions. The component elements and the description thereof are examples, and are not limited by the expression of the present specification. The component elements may also be identified with names different from those in the present specification. In addition, the component elements may be described by an expression different from the expression in the present specification.

In the following description, “suppress” is defined as, for example, preventing the occurrence of an event, an action, or an influence, or reducing the degree of the event, the action, or the influence. In addition, in the following description, “restrict” is defined as, for example, preventing movement or rotation, or allowing movement or rotation within a predetermined range and preventing movement or rotation beyond the predetermined range.

FIG. 1 is an exemplary perspective view illustrating a hard disk drive (HDD) 10 according to the first embodiment in an exploded manner. The HDD 10 is an example of a disk device, and may also be referred to as an electronic device, a storage device, an external storage device, or a magnetic disk device.

As illustrated in the drawings, in the present specification, an X axis, a Y axis, and a Z axis are defined for convenience. The X axis, the Y axis, and the Z axis are orthogonal to each other. The X axis is provided along the width of the HDD 10. The Y axis is provided along the length of the HDD 10. The Z axis is provided along the thickness of the HDD 10.

Furthermore, in the present specification, an X direction, a Y direction, and a Z direction are defined. The X direction is a direction along the X axis and includes a +X direction indicated by an arrow of the X axis and a -X direction which is an opposite direction of the arrow of the X axis. The Y direction is a direction along the Y axis, and includes a +Y direction indicated by an arrow of the Y axis and a -Y direction which is an opposite direction of the arrow of the Y axis. The Z direction is a direction along the Z axis and includes a +Z direction indicated by an arrow of the Z axis and a -Z direction which is an opposite direction of the arrow of the Z axis.

As illustrated in FIG. 1, the HDD 10 includes a housing 11, a plurality of magnetic disks 12, a spindle motor 13, a head stack assembly (HSA) 14, a voice coil motor (VCM) 15, a ramp load mechanism 16, and a printed circuit board (PCB) 17. The magnetic disk 12 may also be referred to as a disk or a platter.

The housing 11 includes a base 21, an inner cover 22, and an outer cover 23. Note that, the housing 11 is not limited to this example. The inner cover 22 is an example of a cover. Each of the base 21, the inner cover 22, and the outer cover 23 is made of metal such as aluminum alloy, for example. Note that, the materials of the base 21, the inner cover 22, and the outer cover 23 are not limited to this example.

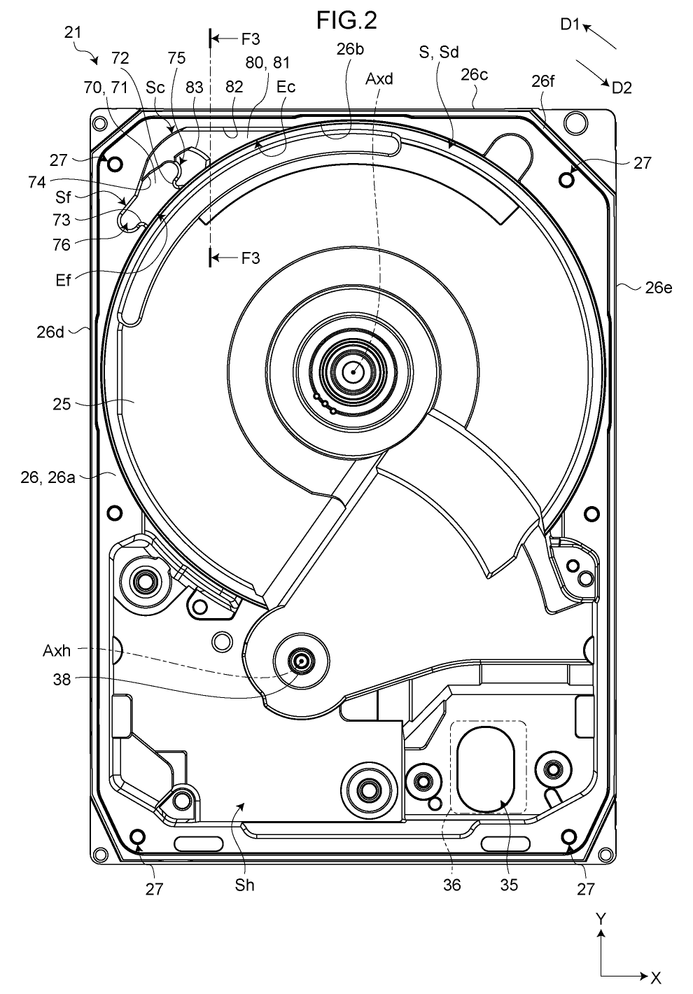

FIG. 2 is an exemplary plan view illustrating the base 21 of the first embodiment. As illustrated in FIG. 2, the base 21 has a substantially rectangular parallelepiped box shape opened in the +Z direction. The base 21 includes a bottom wall 25 and the side wall 26. The bottom wall 25 has a substantially rectangular (quadrangular) plate shape that expands so as to be substantially orthogonal to the Z direction. The side wall 26 protrudes substantially in the +Z direction from the edge of the bottom wall 25 and has a substantially rectangular frame shape.

The base 21 has an internal space S. The internal space S is defined by the bottom wall 25 and the side wall 26. The side wall 26 surrounds the internal space S. The plurality of magnetic disks 12, the spindle motor 13, the HSA 14, the VCM 15, and the ramp load mechanism 16 are arranged in the internal space S.

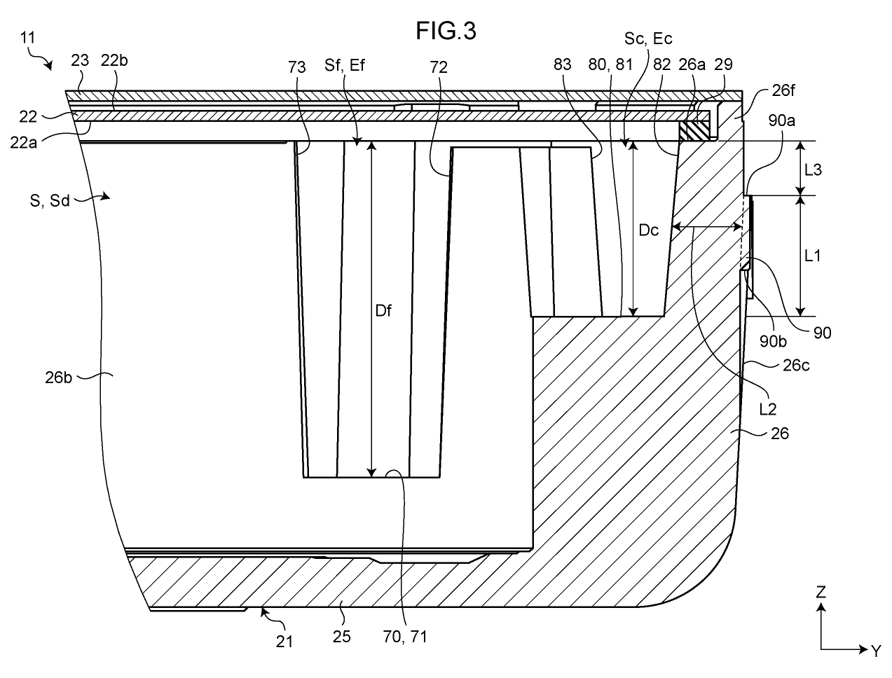

FIG. 3 is an exemplary cross-sectional view illustrating a portion of the housing 11 of the first embodiment taken along line F3-F3 of FIG. 2. As illustrated in FIGS. 2 and 3, the side wall 26 includes a support surface 26a, an inner peripheral surface 26b, a plurality of outer surfaces 26c, 26d, and 26e, and a rib 26f.

As illustrated in FIG. 3, the support surface 26a is a part of the end surface of the side wall 26 in the +Z direction. The support surface 26a is substantially flat and faces the substantially +Z direction. The support surface 26a has a frame shape around the internal space S. Note that, the support surface 26a is not limited to this example. As illustrated in FIG. 2, the base 21 is further provided with a plurality of screw holes 27. The plurality of screw holes 27 opens on the support surface 26a.

The inner peripheral surface 26b is a semi-cylindrical curved surface extending around an axis Axd. That is, the axis Axd in the present embodiment is the axis of the inner peripheral surface 26b and extends substantially in the Z direction. Note that, the axis Axd and the axis of the inner peripheral surface 26b may be shifted from each other.

Hereinafter, in the present specification, an axial direction, a radial direction, and a circumferential direction are defined for convenience. The axial direction is a direction along the axis Axd and is substantially equal to the Z direction. The radial direction is a direction orthogonal to the axis Axd. The circumferential direction is a direction around the axis Axd.

The circumferential direction includes a first circumferential direction D1 and a second circumferential direction D2 illustrated in FIG. 2. The first circumferential direction D1 is one direction around the axis Axd. The second circumferential direction D2 is a direction opposite to the first circumferential direction D1.

The inner peripheral surface 26b extends in the substantially -Z direction from an inner edge of the support surface 26a. The -Z direction is one direction along the axis Axd, and is an example of the first direction. Note that, other portions may be provided between the support surface 26a and the inner peripheral surface 26b.

The outer surfaces 26c, 26d, and 26e are exposed to the outside of the housing 11. The outer surface 26c is opposite the inner peripheral surface 26b. In addition, one part of each of the outer surfaces 26d and 26e is opposite the inner peripheral surface 26b. The other part of each of the outer surfaces 26d and 26e is opposite the inner surface of the side wall 26 other than the inner peripheral surface 26b.

The outer surface 26c is, for example, an end surface of the base 21 in the +Y direction. The outer surface 26c faces substantially in the +Y direction as a whole. The outer surface 26d is an end surface of the base 21 in the -X direction, and faces substantially in the -X direction as a whole. The outer surface 26e is an end surface of the base 21 in the +X direction, and faces substantially in the +X direction as a whole.

The rib 26f protrudes substantially in the +Z direction from an outer edge of the support surface 26a. The rib 26f has a frame shape surrounding the support surface 26a. Therefore, the screw hole 27 is located inside the rib 26f. An end portion of the rib 26f in the +Z direction is substantially flat.

The internal space S is recessed in the -Z direction from the support surface 26a. Thus, the internal space S opens on the support surface 26a. The internal space S includes a disk chamber Sd and an HSA chamber Sh. Each of the disk chamber Sd and the HSA chamber Sh is a part of the internal space S.

The disk chamber Sd is defined by, for example, the bottom wall 25 and the inner peripheral surface 26b. That is, the disk chamber Sd is located inside the inner peripheral surface 26b. The axis Axd extends through the disk chamber Sd. The HSA chamber Sh is separated farther from the outer surface 26c than the disk chamber Sd and communicates with the disk chamber Sd.

As illustrated in FIG. 1, the HDD 10 further includes a plurality of screws 28. The inner cover 22 is disposed on the support surface 26a and is attached to the side wall 26 by the plurality of screws 28. Accordingly, the inner cover 22 seals the internal space S. In other words, the inner cover 22 covers the internal space S.

As illustrated in FIG. 3, the inner cover 22 includes an inner surface 22a and an outer surface 22b. The inner surface 22a faces the internal space S, the bottom wall 25, and the support surface 26a. The outer surface 22b is opposite the inner surface 22a.

The HDD 10 further includes a gasket 29. The gasket 29 has a frame shape (endless shape) approximately along the inner edge of the support surface 26a. The gasket 29 is made of, for example, synthetic rubber having low helium permeability. The gasket 29 may be made of another material.

The gasket 29 is interposed between the inner surface 22a of the inner cover 22 and the support surface 26a of the side wall 26. That is, the inner cover 22 is supported by the support surface 26a via the gasket 29. The gasket 29 hermetically seals a gap between the inner cover 22 and the side wall 26.

For example, each of the plurality of screws 28 passes through the inner cover 22 outside the gasket 29 and is fitted into the corresponding screw holes 27. As a result, the plurality of screws 28 attaches the inner cover 22 to the side wall 26.

The outer cover 23 covers the inner cover 22 and is attached to the side wall 26. For example, the outer cover 23 is welded to the rib 26f. As a result, the outer cover 23 hermetically seals the inside of the housing 11 including the internal space S. Note that, the outer cover 23 may be omitted.

As illustrated in FIG. 1, the inner cover 22 is provided with a vent 31. In addition, the outer cover 23 is provided with a vent 32. After components are arranged in the internal space S and the inner cover 22 and the outer cover 23 are attached to the base 21, the air in the internal space S is removed from the vents 31 and 32. Furthermore, a gas different from air is filled into the internal space S through the vents 31 and 32.

The gas to fill the internal space S is, for example, low density gas having a density lower than air, inert gas having low reactivity, or the like. For example, the internal space S is filled with helium. Note that, the internal space S may be filled with another fluid such as air.

The HDD 10 further includes a seal 33 such as an aluminum seal. The seal 33 is attached to the outer cover 23 to hermetically seal the vent 32. The seal 33 restricts helium in the internal space S from leaking from the vent 32 to the outside of the housing 11.

As illustrated in FIG. 2, a through hole 35 is provided in the bottom wall 25. The through hole 35 penetrates the bottom wall 25 in the substantially Z direction. The through hole 35 allows the HSA chamber Sh and the outside of the housing 11 to communicate with each other.

As virtually indicated by a two-dot chain line in FIG. 2, the housing 11 further includes a relay board 36. The relay board 36 is attached to the bottom wall 25 so as to hermetically seal the through hole 35. The relay board 36 includes, for example, a rigid board such as a glass epoxy board and two connectors mounted on both surfaces of the board.

As illustrated in FIG. 1, the plurality of magnetic disks 12 is arranged so as to be orthogonal to the Z direction. The plurality of magnetic disks 12 is arranged in the Z direction with a gap interposed therebetween. Magnetic recording layers are coated on both surfaces of the magnetic disk 12.

The plurality of magnetic disks 12 is housed in the disk chamber Sd. The inner peripheral surface 26b of the base 21 faces all the outer edges of the plurality of magnetic disks 12. A distance between the inner peripheral surface 26b and the magnetic disk 12 is set to be substantially constant.

The spindle motor 13 is attached to the bottom wall 25 of the base 21 and supports the plurality of magnetic disks 12. The plurality of magnetic disks 12 is held by a hub of the spindle motor 13 with, for example, a clamp spring.

The spindle motor 13 integrally rotates the plurality of magnetic disks 12 with respect to the housing 11 in the first circumferential direction D1 around the axis Axd. In the present embodiment, the axis Axd is the axis of the magnetic disk 12 and the spindle motor 13, and is also the center of rotation of the magnetic disk 12 and the spindle motor 13. Note that, the axis Axd is not limited to this example.

The housing 11 further includes a support shaft 38. The support shaft 38 protrudes from the bottom wall 25 in the substantially +Z direction, for example. The HSA 14 is rotatably supported by the support shaft 38. The support shaft 38 and the HSA 14 are disposed in the HSA chamber Sh.

The HSA 14 can rotate around the axis Axh with respect to the housing 11. The axis Axh is a virtual axis extending substantially in the Z direction. The axis Axh is, for example, the center of rotation of the HSA 14 and also the axis of the support shaft 38.

The HSA 14 includes a carriage 41, a plurality of head gimbal assemblies (HGAs) 42, and a flexible printed circuit (FPC) 43. The carriage 41 includes an actuator block 45 and a plurality of arms 46.

The actuator block 45 is attached to the support shaft 38 via a bearing so as to be rotatable around the axis Axh, for example. The plurality of arms 46 protrudes from the actuator block 45 substantially in parallel in a direction substantially orthogonal to the axis Axh.

Each of the plurality of HGAs 42 includes a magnetic head 51 and a suspension 52. The magnetic head 51 may also be referred to as a slider. The magnetic head 51 records and reproduces information with respect to a corresponding one of the plurality of magnetic disks 12. In other words, the magnetic head 51 reads and writes information from and to the magnetic disk 12. The suspension 52 is attached to the arm 46 and holds the magnetic head 51.

The suspension 52 includes a base plate 55, a load beam 56, and a flexure 57. The base plate 55 is attached to the distal end of the arm 46. The load beam 56 has a plate shape thinner than the base plate 55. The load beam 56 is attached to the base plate 55 and extends from the base plate 55.

The flexure 57 is a kind of FPC of an elongated belt shape. The flexure 57 includes, for example, a metal backing plate, an insulating base layer, a conductive layer, and an insulating cover layer.

The flexure 57 extends along the arm 46, the base plate 55, and the load beam 56. A rotatable gimbal portion is provided at one end portion of the flexure 57. The magnetic head 51 is attached to the gimbal portion of the flexure 57.

The other end portions of the plurality of flexures 57 are connected to one end portion of the FPC 43. The end portion of the FPC 43 is attached to the actuator block 45. The flexure 57 electrically connects the magnetic head 51 and the FPC 43. The other end of the FPC 43 is connected to the connector of the relay board 36.

The VCM 15 is housed in the HSA chamber Sh and includes a voice coil, a pair of yokes, and a magnet provided on the yokes. The voice coil is held by the actuator block 45. The VCM 15 rotates the carriage 41 around the axis Axh to move the magnetic head 51 to a desired position.

When the magnetic head 51 moves to the outer edge of the magnetic disk 12 by the rotation of the HSA 14 by the VCM 15, the ramp load mechanism 16 holds the magnetic head 51 at a position separated from the magnetic disk 12.

The PCB 17 is disposed outside the housing 11 and attached to the bottom wall 25. The PCB 17 is, for example, a rigid board such as a glass epoxy board, and is a multilayer board, a build-up board, or the like. Various electronic components such as a connector electrically connected to the FPC 43 through the relay board 36, an interface (I/F) connector connected to the host computer, and a controller that controls the operation of the HDD 10 are mounted on the PCB 17. A controller of the PCB 17 controls the spindle motor 13, the VCM 15, and the magnetic head 51.

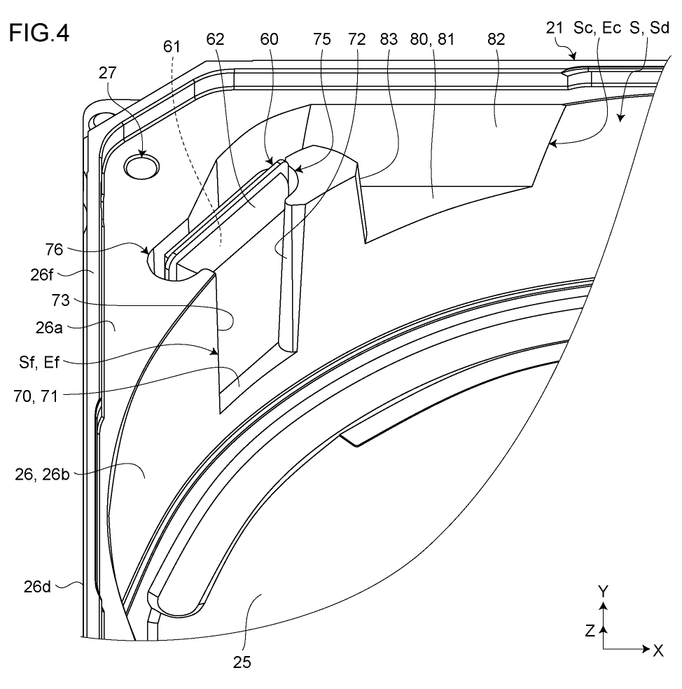

FIG. 4 is an exemplary perspective view illustrating a part of the base 21 and a filter 60 of the first embodiment. As illustrated in FIG. 4, the HDD 10 further includes the filter 60. The filter 60 includes, for example, an adsorbent 61 and a membrane 62. Note that, the filter 60 is not limited to this example. The filter 60 is disposed in the internal space S to cause the adsorbent 61 to adsorb predetermined gases in the internal space S.

The adsorbent 61 is, for example, a gas collector such as activated carbon. The adsorbent 61 adsorbs various kinds of organic substances including gases. That is, the filter 60 collects various kinds of organic substances. The gases (organic gases) adsorbed on the activated carbon is an example of substances different from the gas filling the internal space. The organic gases are different from helium filling the internal space S. The activated carbon as the adsorbent 61 may further adsorb moisture.

The membrane 62 is made of a permeable membrane capable of holding adsorbent 61. In other words, the membrane 62 restricts adsorbent 61 from passing through the membrane 62. For example, the membrane 62 is a non-woven fabric. Note that, the membrane 62 is not limited to this example.

The membrane 62 covers the adsorbent 61. The membrane 62 wraps the adsorbent 61 such that, for example, the filter 60 has a substantially plate shape (rectangular parallelepiped shape). Note that, the shape of the filter 60 is not limited to this example.

The filter 60 is not limited to the above example. For example, the filter 60 may collect dust. The dust is an example of a substance, and is a substance different from helium filled in the internal space S. That is, the substance may be any of a solid, a gas, and a liquid.

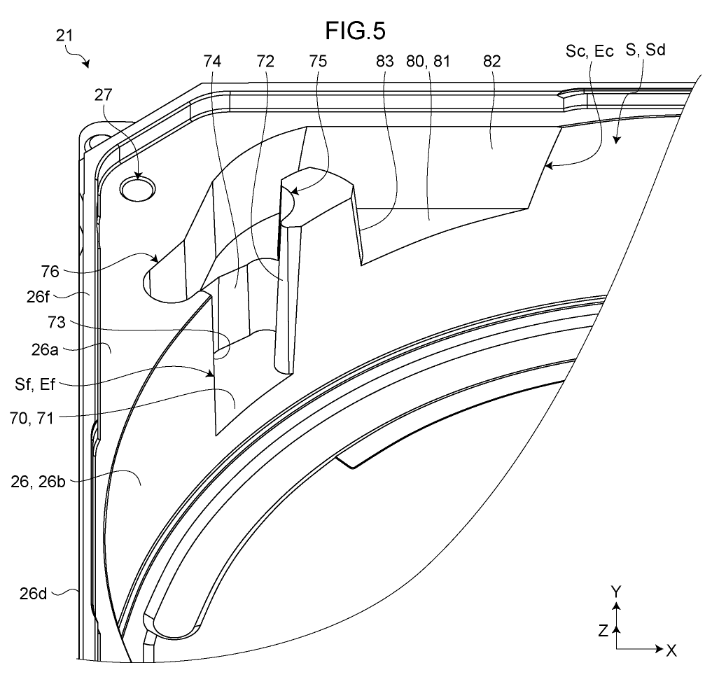

FIG. 5 is an exemplary perspective view illustrating a part of the base 21 of the first embodiment. As illustrated in FIG. 5, the internal space S further includes a filter chamber Sf and the flow path Sc. Each of the filter chamber Sf and the flow path Sc is a part of the internal space S.

The filter chamber Sf is recessed approximately radially outward from the inner peripheral surface 26b. That is, the filter chamber Sf opens on the inner peripheral surface 26b to communicate with the disk chamber Sd. The filter chamber Sf includes an open end Ef. The open end Ef is one end of the filter chamber Sf that opens on the inner peripheral surface 26b.

The side wall 26 of the base 21 further includes an inner surface 70 that defines the filter chamber Sf. The inner surface 70 has a bottom surface 71, two side surfaces 72 and 73, and an end surface 74. Note that the inner surface 70 is not limited to this example.

The bottom surface 71 is provided at an end portion of the filter chamber Sf in the -Z direction. The bottom surface 71 is substantially flat and faces the substantially +Z direction. The bottom surface 71 is separated in the +Z direction from an end of the inner peripheral surface 26b in the -Z direction. Note that, the position of the bottom surface 71 is not limited to this example.

Each of the side surfaces 72 and 73 and the end surface 74 extends between the support surface 26a and the bottom surface 71. Therefore, each of the side surfaces 72 and 73 and the end surface 74 extends approximately in the +Z direction from the bottom surface 71.

The side surface 72 faces approximately in the first circumferential direction D1. The side surface 73 is separated from the side surface 72 in the first circumferential direction D1 and faces the second circumferential direction D2. That is, the two side surfaces 72 and 73 face each other. The end surface 74 is provided at the other end of the filter chamber Sf and extends between the two side surfaces 72 and 73.

The side wall 26 is further provided with two grooves 75 and 76. The groove 75 is open on the support surface 26a and the side surface 72. The groove 76 is open on the support surface 26a and the side surface 73. As illustrated in FIG. 4, the filter 60 is fitted into the grooves 75 and 76. As a result, the filter 60 is housed in the filter chamber Sf while being directly held by the base 21. The base 21 may hold the filter 60 indirectly via another member.

The flow path Sc is recessed approximately radially outward from the inner peripheral surface 26b. That is, the flow path Sc opens on the inner peripheral surface 26b to communicate with the disk chamber Sd. The flow path Sc has an open end Ec. The open end Ec is an example of a connection port, and is one end of the flow path Sc open to the inner peripheral surface 26b.

The -Z directional end of the open end Ec is closer to the bottom wall 25 than at least one of the plurality of magnetic disks 12. In other words, the -Z directional end of the open end Ec is farther spaced from the support surface 26a than at least one of the plurality of magnetic disks 12. Because of this, the open end Ec is open toward the outer edge of at least one of the plurality of magnetic disks 12.

The open end Ec of the flow path Sc is spaced from the open end Ef of the filter chamber Sf in the second circumferential direction D2. That is, the flow path Sc opens on the inner peripheral surface 26b away from the filter chamber Sf in the second circumferential direction D2 around the axis Axd. A part of the inner peripheral surface 26b extends in the circumferential direction between the two open ends Ef and Ec.

As illustrated in FIG. 5, the other end of the flow path Sc opens on the end surface 74 of the filter chamber Sf. That is, the flow path Sc allows the disk chamber Sd and the filter chamber Sf to communicate with each other. Another part of the internal space S may be located between the flow path Sc and the disk chamber Sd or between the flow path Sc and the filter chamber Sf.

The side wall 26 of the base 21 further includes an inner surface 80 that defines the flow path Sc. The inner surface 80 has a bottom surface 81 and two side surfaces 82 and 83. Note that, the inner surface 80 is not limited to this example.

The bottom surface 81 is provided at an end portion of the flow path Sc in the -Z direction. In the present embodiment, the bottom surface 81 is substantially flat and faces in the substantially +Z direction. That is, the distance along the axis Axd between the support surface 26a and the bottom surface 81 is substantially constant. Note that, the bottom surface 81 is not limited to this example.

The bottom surface 81 is separated in the +Z direction from the -Z directional end of the inner peripheral surface 26b. As illustrated in FIG. 3, along the axis Axd a distance Dc between the support surface 26a and the bottom surface 81 of the flow path Sc is shorter than a distance Df between the support surface 26a and the bottom surface 71 of the filter chamber Sf. That is, in the -Z direction, the distance Dc between the support surface 26a and the end of the flow path Sc is shorter than the distance Df between the support surface 26a and the end of the filter chamber Sf.

Each of the side surfaces 82 and 83 extends between the support surface 26a and the bottom surface 81. Therefore, each of the side surfaces 82 and 83 extends approximately in the +Z direction from the bottom surface 81. The two side surfaces 82 and 83 face each other.

In the present embodiment, the distance between the two side surfaces 82 and 83 slightly decreases in the -Z direction. That is, the flow path Sc is tapered in the -Z direction. Note that, the flow path Sc is not limited to this example.

The base 21 further includes a gate 90. The gate 90 is, for example, a columnar portion of the side wall 26, protruding from the outer surface 26c. That is, the gate 90 is included in the outer surface 26c. Note that, the shape of the gate 90 is not limited to this example, and may be a quadrangular prism, a triangular prism, or another shape. In addition, the gate 90 may be provided in another part of the base 21, such as the outer surface 26d or the outer surface 26e.

In the present embodiment, the base 21 is manufactured by, for example, aluminum die-casting. That is, the base 21 is made of a material (molten metal) filled in the mold. The gate 90 is a part of the base 21 made of a material supplied to the gate of the mold. Note that, the base 21 may be manufactured by another method such as casting.

The gate 90 is located in a region of the outer surface 26c of the side wall 26, the region being opposite to the side surface 82 of the flow path Sc. Thus, the flow path Sc is adjacent to the gate 90 and extends between a neighborhood of the gate 90 and the disk chamber Sd.

An end 90a of the gate 90 in the +Z direction is closer to the support surface 26a in the direction along the axis Axd than an end (bottom surface 81) of the flow path Sc in the -Z direction. An end 90b of the gate 90 in the -Z direction is also closer to the support surface 26a in the direction along the axis Axd than the bottom surface 81. The end 90b may be farther from the support surface 26a in the direction along the axis Axd than the bottom surface 81.

In the present embodiment, a distance L1 along the axis Axd between the +Z directional end 90a of the gate 90 and the -Z directional end (bottom surface 81) of the flow path Sc is 6 mm or less. The distance L1 is 2/3 or less of a distance L2 between the gate 90 and the flow path Sc. The ratio between the distance L1 and the distance L2 is about 3:2. In addition, the distance L1 is 4/3 or less of a distance L3 along the axis Axd between the end 90a of the gate 90 and the support surface 26a. The ratio between the distance L1 and the distance L3 is about 6:4.5. Note that, the distances L1, L2, and L3 are not limited to the above examples.

The spindle motor 13 rotates the magnetic disk 12 in the first circumferential direction D1 with respect to the housing 11. The rotation of the magnetic disk 12 generates a flow of helium in the internal space S. In the disk chamber Sd, the helium flows radially outward and flows in the first circumferential direction D1. Therefore, the flow of helium flows into the flow path Sc from the open end Ec.

The flow of helium passes through the flow path Sc and flows into the filter chamber Sf. In the filter chamber Sf, in a case where organic gas is present in the helium, the adsorbent 61 of the filter 60 adsorbs the organic gas. That is, helium passes through the filter 60 to remove the organic gas. In addition, in a case where dust is mixed in the flow of helium, the dust is collected by the filter 60. The helium flows out from the filter chamber Sf to the disk chamber Sd through the open end Ef.

As described above, the filter 60 collects organic gas and dust from the flow of helium generated by the magnetic disk 12. Therefore, the filter chamber Sf and the flow path Sc are provided in the vicinity of the disk chamber Sd.

In addition, at a corner portion in the vicinity of the disk chamber Sd and between the outer surface 26c and another outer surface 26d, the thickness of the side wall 26 is relatively large and relatively uniform. Therefore, metal flow (flow of material) at the corner portion is relatively good at the time of manufacturing the base 21. The gate 90 is provided at the corner portion. That is, the filter chamber Sf, the flow path Sc, and the gate 90 are all provided at the corner portion. Note that, the filter chamber Sf, the flow path Sc, and the gate 90 may be provided at a corner portion between the outer surface 26c and the outer surface 26e.

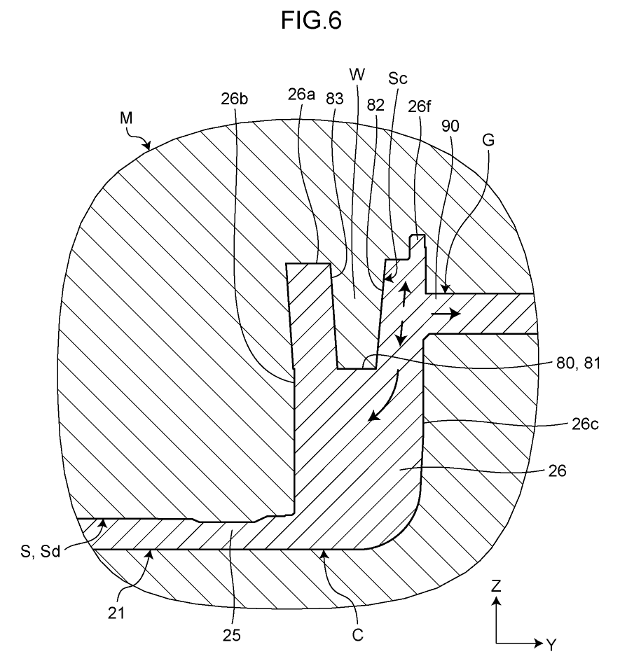

FIG. 6 is an exemplary cross-sectional view schematically illustrating the base 21 and a mold M of the first embodiment. The base 21 is made by, for example, aluminum die-casting using the mold M. The mold M is provided with a cavity C and a gate G communicating with the cavity C. Furthermore, the mold M has a wall W forming the flow path Sc. The gate G opens toward the wall W.

The material (molten metal) of the base 21 is supplied from the gate G to the cavity C of the mold M. The molten metal flows in the space between the gate G and the wall W substantially in the +Z direction, the -Z direction, the -X direction, and the +X direction along the wall W.

The space between the gate G and the wall W is relatively narrow and has a large flow resistance. If bubbles contained in the molten metal stagnate between the gate G and the wall W, a mold cavity or a chip may occur in the base 21. However, as described above, the distance L1 is set to be relatively short. That is, the distance between the gate G and the end of the wall W in the -Z direction is also short. Therefore, the molten metal quickly passes through a narrow space between the gate G and the wall W, and reaches a wide portion of the cavity C.

As described above, a portion having a large flow resistance in the cavity C is set to be relatively short. Therefore, the filling pressure in the vicinity of the gate G is less likely to decrease. Therefore, a mold cavity or a chip hardly occurs in the base 21. That is, airtightness of the housing 11 is maintained, and leakage of helium from the internal space S and intrusion of outside air into the internal space S hardly occur.

The HDD 10 according to the first embodiment described above includes the base 21, the inner cover 22, the magnetic disk 12, and the filter 60. The base 21 includes the support surface 26a, the inner peripheral surface 26b extending around the axis Axd, the outer surface 26c opposite the inner peripheral surface 26b, and the gate 90 located on the outer surface 26c. The base 21 is provided with the internal space S recessed from the support surface 26a in the -Z direction along the axis Axd. The internal space S is filled with helium. The inner cover 22 is supported by the support surface 26a to seal the internal space S. The magnetic disk 12 is disposed in the internal space S to be rotatable around the axis Axd with respect to the base 21. The filter 60 is disposed in the internal space S and is configured to collect substances different from helium. The internal space S includes the disk chamber Sd, the filter chamber Sf, and the flow path Sc. The disk chamber Sd is located inside the inner peripheral surface 26b to house the magnetic disk 12. The filter chamber Sf opens on the inner peripheral surface 26b to communicate with the disk chamber Sd and house the filter 60. The flow path Sc opens on the inner peripheral surface 26b away from the filter chamber Sf around the axis Axd to allow the disk chamber Sd and the filter chamber Sf to communicate with each other, and is located between the gate 90 and the disk chamber Sd. In the -Z direction the distance Dc between the support surface 26a and the end (bottom surface 81) of the flow path Sc is shorter than the distance Df between the support surface 26a and the end (bottom surface 71) of the filter chamber Sf.

The flow path Sc is adjacent to the gate 90 and shallower in depth from the support surface 26a than the filter chamber Sf. The material of the base 21 is filled into the mold M through the gate G. In the mold M, the material flows around the wall W that forms the internal space S. Due to the flow path Sc being smaller in depth than the filter chamber Sf, there is a relatively long distance between the flow path Sc and the bottom of the base 21. This allows the material to easily flow between the flow path Sc and the bottom of the base 21. As a result, the HDD 10 according to the present embodiment can be improved in the fluidity or flow of material for manufacturing the base 21 as compared with an HDD 10 having the gate 90 set adjacent to the filter chamber Sf of a larger depth, for example, which leads to reduce or prevent the occurrence of defects such as mold cavities or chips in the base 21. In this manner, the HDD 10 can reduce or avoid leakage of helium from the internal space S.

Along the axis Axd, the distance between the +Z directional end 90a of the gate 90 and the -Z directional end (bottom surface 81) of the flow path Sc is 6 mm or less. With a longer distance L1 set, the material flow of the base 21 may become stagnant in a narrow part of the mold M between the flow path Sc and the outer surface 26c. In the HDD 10 of the present embodiment, however, the distance L1 is set to 6 mm or less. In this case, the material can generally flow smoothly. As such, the HDD 10 of the present embodiment can be improved in material fluidity for manufacturing the base 21.

Along the axis Axd, the distance L1 between the +Z directional end 90a of the gate 90 and the -Z directional end (bottom surface 81) of the flow path Sc is 2/3 or less of the distance L2 between the gate 90 and the flow path Sc. With a longer distance L1 set or a shorter distance L2 set, the material flow of the base 21 may become stagnant in a part of the mold M between the flow path Sc and the outer surface 26c. In the HDD 10 of the present embodiment, however, the distance L1 is set to a shorter distance or the distance L2 is set to a longer distance. This setting allows the material to generally flow smoothly. As a result, the HDD 10 of the present embodiment can be improved in the material fluidity for manufacturing the base 21.

Along the axis Axd, the distance L1 between the +Z directional end 90a of the gate 90 and the -Z directional end (bottom surface 81) of the flow path Sc is 4/3 or less of the distance L3 between the +Z directional end 90a of the gate 90 and the support surface 26a. If a longer distance L1 is set, the material flow of the base 21 may become stagnant in a narrow part of the mold M between the flow path Sc and the outer surface 26c. In the HDD 10 of the present embodiment, however, the distance L1 is set to a shorter distance. This setting allows the material to generally flow smoothly. As such, the HDD 10 of the present embodiment can be improved in the material fluidity for manufacturing the base 21.

The base 21 directly holds the filter 60. Thereby, the HDD 10 can omit including components for holding the filter 60, leading to reducing the number of components and cost.

The flow path Sc has the open end Ec opening on the inner peripheral surface 26b. The -Z directional end of the open end Ec is more apart from the support surface 26a than the magnetic disk 12. That is, the open end Ec opens on the inner peripheral surface 26b toward the magnetic disk 12. Owing to such an open end Ec, the HDD 10 of the present embodiment can allow the flow of helium, when caused by the rotation of the magnetic disk 12, to be smoothly introduced into the flow path Sc from the open end Ec. As such, according to the HDD 10, the filter 60 can collect the organic gases with improved efficiency.

### Second Embodiment

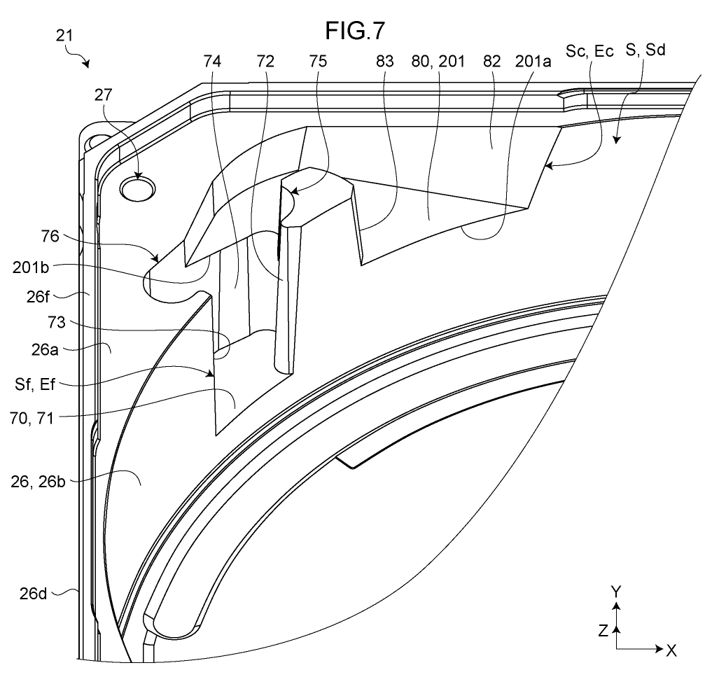

Hereinafter, a second embodiment will be described with reference to FIG. 7. Note that, in the following description of embodiments, component elements having functions similar to those of the component elements already described are denoted by the same reference signs as those of the component elements already described, and the description thereof may be omitted. In addition, the plurality of component elements denoted by the same reference signs does not necessarily have all the functions and properties in common, and may have different functions and properties according to each embodiment.

FIG. 7 is an exemplary perspective view illustrating a part of the base 21 according to the second embodiment. As illustrated in FIG. 7, the base 21 of the second embodiment has a bottom surface 201 instead of the bottom surface 81 of the flow path Sc. The bottom surface 201 is substantially equal to the bottom surface 81 except the points described below.

The bottom surface 201 extends obliquely between two ends 201a and 201b. One end 201a of the bottom surface 201 is provided at the open end Ec. The other end 201b of the bottom surface 201 is provided at the boundary between the filter chamber Sf and the flow path Sc.

The end 201a of the bottom surface 201 is more apart from the support surface 26a than the end 201b. The flow path Sc is thus tapered toward the filter chamber Sf. Specifically, the distance along the axis Axd between the support surface 26a and the -Z directional end (bottom surface 201) of the flow path Sc decreases toward the filter chamber Sf. That is, the cross-sectional area of the flow path Sc gradually decreases toward the filter chamber Sf.

Since the cross-sectional area of the flow path Sc gradually decreases, the flow of helium in the flow path Sc is accelerated toward the filter chamber Sf. Since the high-speed flow of helium collides with the filter 60, the filter 60 can efficiently collect organic gas and dust in helium.

The flow path Sc is not limited to this example. For example, the width of the flow path Sc may gradually decrease toward the filter chamber Sf. That is, the distance between the two side surfaces 82 and 83 may gradually decrease toward the filter chamber Sf.

In the HDD 10 of the second embodiment described above, the flow path Sc is tapered toward the filter chamber Sf. The flow of helium, when caused by the rotation of the magnetic disk 12, runs into the filter chamber Sf through the flow path Sc. The tapered flow path Sc toward the filter chamber Sf can accelerate the flow of helium toward the filter chamber Sf. In this manner, according to the HDD 10, the filter 60 can collect the substances with improved efficiency.

Along the axis Axd, the distance between the support surface 26a and the -Z directional end (bottom surface 201) of the flow path Sc decreases toward the filter chamber Sf. As a result, according to the HDD 10 of the present embodiment, in the mold M the wall W to form the flow path Sc is not to decrease in width as compared with forming the flow path Sc having a decreasing width toward the filter chamber Sf. Consequently, the HDD 10 of the present embodiment can allow the mold M to be enhanced in strength, improving the manufacturing efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a base with an internal space, including
a support surface,
an inner peripheral surface extending around an axis,
an outer surface opposite the inner peripheral surface, and
a gate located on the outer surface, wherein the internal space is recessed from the support surface in a first direction along the axis, and is filled with a gas;
a cover that is supported by the support surface to seal the internal space;
a magnetic disk that is disposed in the internal space to be rotatable around the axis with respect to the base; and
a filter that is disposed in the internal space and configured to collect a substance different from the gas; wherein
the internal space includes
a disk chamber located inside the inner peripheral surface to house the magnetic disk,
a filter chamber opening on the inner peripheral surface to communicate with the disk chamber and house the filter, and
a flow path opening on the inner peripheral surface away from the filter chamber around the axis, allowing the disk chamber and the filter chamber to communicate with each other, and being located between the gate and the disk chamber, and
in the first direction, a distance between the support surface and an end of the flow path is shorter than a distance between the support surface and an end of the filter chamber.

2. The disk device according to claim 1, wherein
along the axis, a distance between an end of the gate in a second direction and the end of the flow path in the first direction is 6 mm or less, the second direction being opposite to the first direction.

3. The disk device according to claim 1, wherein
along the axis, a distance between an end of the gate in a second direction and the end of the flow path in the first direction is 2/3 or less of a distance between the gate and the flow path, the second direction being opposite to the first direction.

4. The disk device according to claim 1, wherein
along the axis, a distance between an end of the gate in a second direction and the end of the flow path in the first direction is 4/3 or less of a distance between an end of the gate and the support surface in the second direction being opposite to the first direction.

5. A disk device comprising:
a base with an internal space, including
a support surface,
an inner peripheral surface extending around an axis,
an outer surface opposite the inner peripheral surface, and
a gate located on the outer surface, wherein the internal space is recessed from the support surface in a first direction along the axis, and is filled with a gas;
a cover that is supported by the support surface to seal the internal space;
a magnetic disk that is disposed in the internal space to be rotatable around the axis with respect to the base; and
a filter that is disposed in the internal space and configured to collect a substance different from the gas; wherein
the internal space includes
a disk chamber inside the inner peripheral surface to house the magnetic disk,
a filter chamber opening on the inner peripheral surface to communicate with the disk chamber and house the filter, and
a flow path opening on the inner peripheral surface away from the filter chamber around the axis, allowing the disk chamber and the filter chamber to communicate with each other, and being located between the gate and the disk chamber, and
along the axis, a distance between an end of the gate in a second direction and an end of the flow path in the first direction is 6 mm or less, the second direction being opposite to the first direction.

6. The disk device according to claim 5, wherein
along the axis, the distance between the end of the gate in the second direction and the end of the flow path in the first direction is 2/3 or less of a distance between the gate and the flow path.

7. The disk device according to claim 5, wherein
along the axis, the distance between the end of the gate in the second direction and the end of the flow path in the first direction is 4/3 or less of a distance between the end of the gate in the second direction and the support surface.

8. The disk device according to claim 1, wherein
the flow path is tapered toward the filter chamber.

9. The disk device according to claim 1, wherein
along the axis, the distance between the support surface and the end of the flow path in the first direction decreases toward the filter chamber.

10. The disk device according to claim 1, wherein
the base directly holds the filter.

11. The disk device according to claim 1, wherein
the flow path has a connection port opening on the inner peripheral surface, and
an end of the connection port in the first direction is more apart from the support surface than the magnetic disk.

12. The disk device according to claim 1, wherein
the gate includes a circular column protruding from the outer surface.
